(19) United States
(12) Patent Application Publication
(10) Pub. No.: US 2007/0275231 A1
(43) Pub. Date: Nov. 29, 2007

(54) Fire Protection Means and Method for the Production Thereof

(75) Inventors: Gerhard Meyer, Wesel (DE); Valentino Villari, Moenchengladbach (DE); Tobias Roth, Marl (DE); Nikolas Wirth, Deulmen (DE); Christian Puettmann, Duelman (DE); Thomas Fenner, Dinslaken (DE); Paul Hendrikx, Venray (NL)

Correspondence Address: MARSHALL, GERSTEIN & BORUN LLP, 233 S. WACKER DRIVE, SUITE 6300, SEARS TOWER, CHICAGO, IL, 60606, US

(73) Assignee: SCHEUTEN GLASGROEP, VENLO (NL)

(21) Appl. No.: 10/539,877

(22) PCT Filed: Dec. 8, 2003
(86) PCT No.: PCT/EP03/14029

§ 371 Date: Nov. 14, 2006

(30) Foreign Application Priority Data
Dec. 18, 2002 (EP) 02028400.6

(51) Int. Cl. B32B 17/10; C09K 21/02

(52) U.S. Cl. 428/325; 428/323; 428/331

(57) ABSTRACT

A fire protection means integratable into a construction element. The inventive fire protection means includes at least one hybrid foil system. At least one foil of the system is coated with intumescent material. A method for producing the fire protection means and a glazing unit provided therewith are also disclosed.

The invention relates to a fire protection means and method for the production thereof.

The invention also relates to the use of the fire protection means in a fire protection glazing unit.

In order to produce fire protection glazing, it is a known procedure to employ intumescent materials that, within a glazing unit having at least two glass panes, form a transparent interlayer that expands in case of fire. When the layer expands, a considerable amount of energy of the occurring heat is absorbed by the water contained in the layer, which causes the water to evaporate. After the evaporation of the water, a foam-like heat shield is formed which, during the further course of the fire, assumes the function of heat insulation for the glass pane that lies behind the fire protection layer as well as for a room that is to be protected.

It is a known procedure to use hydrogels to form such fire protection layers. The main constituent of these hydrogel layers is usually water with admixtures of salts and stabilizing polymers. Here, the stabilizing polymers serve as gel formers. Such a fire protection layer consisting of a hydrogel is described, for example, in German Patent DE 35 30 968. In this case, the aqueous phase of the hydrogel consists of 70% to 90% water and approximately 10% to 30% of a water-soluble salt. Moreover, a water-soluble, anticorrosive substance is added to the gel in order to prevent the corrosion of a metallic spacing frame arranged between the two glass panes of the glazing.

German Preliminary Published Application DE 195 25 263 likewise discloses a fire protection layer consisting of a hydrogel. Here, the gel-forming solid phase consists of a polymer in the form of a cross-linked polyvinyl alcohol.

Furthermore, fire protection mixtures are used that have water bonded to water glass, at least one cellulose derivative and advantageously preservatives. The preservative can be selected, for example, from the group made up of copper sulfate, copper acetate, benzoic acid or mixtures thereof.

With the known methods for the production of intumescent layers for fire protection glazing, the material is applied into the glazing preferably by means of pouring or gel and resin-casting methods in which the appertaining material is applied between two panes that are held apart from each other.

In the case of pouring methods, the intumescent material is poured onto a pane, after which the second pane is applied over it. Such a method is described, for example, in German Preliminary Published Application DE 44 35 843. Here, a drainage protection rim made of putty is placed onto a horizontally positioned glass pane, and then a fire protection solution is poured onto the glass pane. The water of the solution is removed by means of drying processes so that the layer solidifies for form a solid fire protection layer.

Conventional pouring methods, however, have a number of drawbacks. For example, time-consuming adjustment of the glass panes is necessary in order to avoid large thickness and moisture gradients over the pane. This is a serious problem especially in the case of large panes since, generally speaking, it is difficult to handle such glass panes. Moreover, when the applied materials are drying, non-homogeneous drying conditions occur that lead to considerable quality problems and poor fire behavior due to non-homogeneities in the chemical composition and in the resultant physical properties in the x, y and z-directions. Furthermore, the dryers used define the dimensions of the panes that can be treated so that only a very limited choice of pane sizes is possible. There are likewise limits as to how the composition of the functional material can be varied since the drying process is very sensitive. Moreover, the drying process itself is very time-consuming and difficult to regulate.

The intumescent fire protection material can also be poured into an already joined double glass pane in which two panes are preferably positioned at a certain distance from each other by means of a frame-like holder. The interstice thus formed is then filled with the appropriate material. This is described, for example, in German Preliminary Published Application DE 195 25 263. The above-mentioned German Patent DE 35 30 968 likewise describes a method for applying free-flowing fire protection material between two pre-mounted silicate glass panes that are joined to each other by means of a spacing frame. The spacing frame is advantageously glued to the glass panes and the hollow spaces are sealed with an adhesive sealing compound such as putty.

The known gel and casting-resin methods have various drawbacks. For example, only production in the final dimensions is possible since the pouring procedure can only be used with prefabricated double glazing having certain dimensions. The constructions are often very thick and heavyweight. In the case of thin layers, problems also arise in connection with the thickness tolerance over the larger dimensions. Due to the flowability of the gel, bulges are formed or even delamination between the gel and the pane can occur. A large problem is also posed by the edge sealing which is necessary to delimit the area of the gel that has been poured in. Furthermore, at times, toxicity problems arise with the fire protection material or with products released during a fire.

Therefore, there is a need for a method for the production of fire protection layers with which the above-mentioned disadvantages do not occur. A major improvement is the approach of producing the fire protection layers separate from the glazing unit into which they are to be installed at a later point in time. German Patent DE 28 15 900, for example, discloses a method for the production of a solid layer of an intumescent material comprising hydrous or hydrated metal salts in which the fluid material is poured into a mold in which it hardens. The mold, however, is placed into a drying chamber for hardening purposes so that the familiar drawbacks of drying processes occur here as well.

German Patent DE 27 52 543 describes a method for the production of a light-permeable, fire-retardant glass pane with at least one solid layer made of hydrated sodium silicate, whereby the layer is sandwiched between two glass panes. The intumescent layer can be formed, for example, on the glass pane; it can be provided as a film on its own, or it can consist of several layers. This patent does not describe how such a film is produced.

German Patent DE 35 09 249 discloses a method for the production of a transparent fire protection sheet. With this method, an aqueous solution of an expandable material is applied onto a support, this layer is dried by applying heat until the residual water content ranges from 20% to 48% by weight and the expandable material thus obtained is applied as at least one layer onto at least one glazing pane. The support used is a rotating drum from which the dried layer of the expandable material is removed using a doctor vane. The water content can be set in such a way that the desired viscosity is achieved.

It is also known to configure non-transparent films for use in buildings in such a way that they have a fire-retardant effect. European Patent EP 0 492 977, for example, describes a fire barrier in the form of a cloth or curtain consisting of a fiberglass woven fabric that is coated with an intumescent material.

International Patent Application WO 96/03854 describes a heat-insulating intumescent coating system that protects a substrate against fire. In this case, a first layer is applied that is thermally degradable in case of fire and that forms a first carbonized, intumescent and rigid foam layer. A second applied layer is likewise thermally degradable and forms a carbonized, intumescent foam layer that has an insulating effect. The density of the insulating layer is half the density of the first layer.

The known methods for the production of a fire protection layer in which the production is separate from the glazing unit, however, are poorly suited for the further processing of the fire protection layer thus produced. This relates, for example, to the transportation, storage and lamination in glazing units.

The objective of the invention is to provide a fire protection means that is easy to transport, store and laminate, whereby the fire protection means is such that it combines a high degree of fire protection with diverse applicability in various environments.

The objective of the invention is also to provide a method for the production of the fire protection means.

According to the invention, this objective is achieved in that the fire protection means comprises at least one hybrid film system in which at least one film is coated with intumescent material.

The objective is also achieved in that the fire protection means is produced as a hybrid film system in a continuous process.

The objective is also achieved by a fire protection means that is to be integrated into a construction element, in which the fire protection means comprises at least two films or film layers that have different chemical compositions and that are transparent at least in sections, whereby at least one of the layers is configured so as to be fire-retardant.

The objective is also achieved by a fire protection means—optionally that is to be integrated into a construction element—that can be produced by means of a continuous cascading method, in which first of all, a film or film layer A is applied and another film or film layer B is applied onto the former, as well as optionally another film or films and/or film layer or layers C is/are applied, characterized in that at least two of the films or film layers A, B and C have different chemical compositions and at least one of the film layers A, B or C is fire-retardant.

The term fire-retardant in the sense of the invention is defined as a layer or film that is capable of absorbing the energy of a fire in order to protect structural components or building sections located behind said layer or film.

In order to further improve the mechanical properties of the fire protection means, it is advantageous for the film system to have at least one layer having a high elasticity.

In order to further improve the mechanical properties of the fire protection means and to simplify its application into various environments, it is advantageous for the film system to have at least one adhesive layer that serves for the integration into environments.

By configuring the fire protection means as a film system, it is possible to use the fire protection means in a wide array of environments. It is especially suitable for use in buildings, for example, in a fire protection wall. In particular, this makes it possible to impart fire protection properties to all kinds of architectural structures, for example, also cantilevered or curved structures.

Another especially preferred use of the film system is in automotive construction, where it can effectively prevent the propagation of flames, thereby increasing the safety of the vehicle occupants. An aspect of the preferred properties of the fire protection means according to the invention is its low weight, which further augments its application possibilities.

Since this system can be adapted to various environments, it is also possible to meet other requirements, for example, a clear view through the fire protection means. Hence, it is especially well-suited for use in fire protection glazing. Fire protection glazing that makes use of the means according to the invention can be processed easily and reliably, for example, by cutting it to size or by working its edges.

An especially advantageous embodiment of the invention is characterized in that at least one constituent of the film system has a siliceous base.

This has the advantage that high fire resistance as well as good mechanical properties can be achieved. Thanks to the use of a siliceous base, a desired elasticity of the fire protection means can be achieved already at relatively low contents of organic additives—preferably less than 10%, especially less than 5%, and down to 0.5%.

The variation of different properties within a single layer which can be laminated, for example, as a film, has the advantage that this makes the fire protection means easier to produce.

Moreover, this makes it possible to achieve a high degree of transparency, presuming a low absorption in the visible spectrum.

The constituents can be varied in the case of a single layer as well as in the case of several layers that differ from each other—example, as films, especially as laminated films.

For a number of application areas, it is advantageous for the film system to consist of several films that have a content of organic and/or inorganic constituents that differs from each other, at least in part.

In this manner, the fire protection means can be even better adapted to different areas of application, preferably in order to enhance the desired properties in terms of the fire protection and other parameters such as chemical resistance or bonding characteristics in relation to the employed environment.

In an especially preferred embodiment of the invention, the film system consists of several layers including at least one layer (core shell model) with a high thermal stability having interior moisture layers. Moreover, the incorporation of strong organically modified layers having a high elasticity is advantageous. This is especially important when it comes to compliance with the pendulum impact requirement of fire protection systems according to DIN 52 337.

The composition of the film system can be adapted to the various requirements without fundamentally affecting the methods used for the later production of the glazing. Thus, when the layer structure is changed, there is no need to change the entire production process for the fire protection glazing units, but rather only the production of the fire protection film. The film can be integrated into the glazing by means of uniform methods that are normally used for the production of laminated safety glass. An integration into existing laminated safety glass processes is greatly facilitated by the adaptability of the novel film system. In an especially preferred embodiment of the invention, the entire hybrid fire protection system is adapted to the environment into which it will be integrated by means of adhesive layers. Here, it is advantageous that the adhesive force of the adhesive layers employed can be selected. The environment includes materials such as, for example, glass, plastic and the like, to which the adhesive layers are adapted.

This, in turn, has the advantage that the fire protection film can be flexibly adapted without having to change entire production processes for glazing.

In an especially preferred embodiment, the film system according to the invention has a high flexibility for the later processing. However, the film systems are advantageously made thinner than conventional fire protection layers. Thin layers simplify the handling of the layers and the structural sizes and especially the total weight of the fire protection glazing can advantageously be reduced. In spite of the envisaged smaller thicknesses, the films, of course, have to withstand the appertaining fire loads.

Additional advantages, special features and practical embodiments of the invention can be gleaned from the subordinate claims and from the following presentation of preferred embodiments which make reference to the drawings.

The film systems according to the invention can be produced in different ways.

It is possible to vary the individual constituents over a broad range and to change the production conditions.

These are all hybrid film systems. This includes the case that uses one layer comprising several partial layers with different ratios of the organic and inorganic constituents as well as the case where one layer contains organic and inorganic constituents in varying ratios.

The basic notion—namely, to incorporate organic as well as inorganic constituents into the fire protection means in order to combine the mechanical and fire-retardant properties—can be varied in many ways.

Due to the multifaceted variation possibilities, the embodiments presented below or rather the constituents and process steps used for this purpose can be combined with each other in order to achieve the desired properties in each case.

It has proven to be especially advantageous to synthesize special silicate-based hybrid materials which, in addition to providing the fire protection properties, also ensure the essential film properties, coupled with adequate long-term stability. The material development work makes use, for example, of known chemical synthesis techniques such as the sol-gel method.

The chemicals used include, for instance: polyols such as, for example, ethylene glycol, 1,3-propane-diol, 1,4-butane-diol, glycerin or sorbitol as well as especially polyglycerins, POSS (polyhedral oligomeric silsesquioxane), polyacids such as, for example, adipic acid, malic acid, tartaric acid, citric acid, oxalic acid or else boric acid, flame-pyrolytically produced powders such as, for example, aluminum oxide, silicon oxide, zirconium oxide or titanium oxide, precipitation silicic acids, silicic sols, metal hydroxides, metal salts such as, for example, zirconyl chloride and titanium tetrachloride, metal alcoholates such as, for example, aluminum-tri-sec-butylate, tetrapropoxy zirconium or titanium tetraisopropylate, metal diketonates such as, for example, aluminum acetyl acetonate, silanes, siloxanes, silicones, organic polymers such as, for example, polyvinyl alcohol, polyvinylamine, polyvinyl sulfonate, polyacrylates, polycarboxylates, polyacrylamide or polydimethyl diallyl ammonium chloride as well as their monomers and oligomer units and copolymers such as, for example, styrene-acrylate copolymers, nano-particles such as, for example, layer silicates such as, for instance, natrosilite (Na₂Si₂O₅), makatite (Na₂Si₄O₈(OH)₂.4H₂O), magadiite (Na₂Si₁₄O₂₉.11H₂O), kenyaite (Na₂Si₂₂O₄₅.10H₂O), kanemite (NaHSi₂O₅.3H₂O), revdite (Na₂Si₂O₅.5H₂O) and grumantite (NaHSi₂O₅.0.9H₂O) and layer silicic acids such as, for example, those having the proximate formula H₂Si_{2y}O_{2y+1} (y=1, 2, 4, 7, 11) and/or nanocomposites such as, for example, organically modified layer silicates and layer silicic acids.

Especially preferred embodiments of the base system are:
1.0 Inorganic Modifications of the Base System
1.1 Examples of Modulus Changes

As is generally known, modulus increases during foaming operations make the foam finer and the foam has a higher viscosity in the melting range. If an acidic silica sol is used to raise the modulus, then a marked pH reduction occurs. This results in a higher compatibility of organic additives.

It is also known that the resulting films have greater brittleness after drying.
1.1.1 Modulus Increase up to 4.4:

100 grams of sodium-water glass (Crystal 0075 made by the INEOS company: molar modulus 3.31, 28.11% SiO₂, 8.76% Na₂O, pH 11.5) are placed into a reaction vessel equipped with a magnetic agitator vane. A spatula is used to add 2 grams of Aerosil A 200 (made by the Degussa company) to the water glass as a solid. This mixture is stirred for 48 hours in a water bath at 50° C. [122° F.] until the Aerosil A 200 has completely dissolved. Subsequently, 15 grams of demineralized water are added in order to adjust the viscosity.

Then another 2 grams of Aerosil A 200 are added as a solid and stirred in a water bath at 50° C. [122° F.] for 48 hours until the Aerosil A 200 has completely dissolved.

Then once again, 2 grams of Aerosil A 200 are added as a solid and stirred in a water bath at 50° C. [122° F.] until the Aerosil A 200 has dissolved. Subsequently, 15 grams of demineralized water are added to the solution and shaken in a shaker until it becomes stirrable.

Then another 2 grams of Aerosil A 200 are added as a solid and stirred in a water bath at 50° C. [122° F.] until the Aerosil A 200 has completely dissolved. Subsequently, 10 grams of demineralized water are added to the solution and shaken in a shaker until it becomes stirrable.

Then another gram of Aerosil A 200 is added as a solid and stirred in a water bath at 50° C. [122° F.] until the Aerosil A 200 has completely dissolved.

Then the mixture is applied onto a plastic film (PET) and dried in an oxygen atmosphere (flow rate: 100 liters per hour) at 80° C. [176° F.] until a residual moisture content of 25% is reached.

Result:

The film thus obtained is clear, homogeneous and, as expected, brittle. When it is foamed, it yields a compact foam with small bubbles and a uniform height distribution.

solids content 30.78%, molar modulus 4.37, 24.91% SiO₂, 5.88% Na₂O, pH 10.5
1.1.2 Modulus Increase up to 4.0:

2.88 grams of Klebosol 30R9 (colloidal silica stabilized with sodium oxide, 30.4% SiO₂, 0.7% Na₂O, pH 10.5, radius 9 nm) are dripped into 19.96 grams of Crystal 0075 (sodium-water glass, 8.32% Na₂O, 28.11% SiO₂, solids content 36.43%, molar modulus 3.49, pH 11.18) in a reaction vessel within 3.5 hours while being stirred (700 rpm) at room temperature. The viscosity rises and the liquid becomes turbid during the dripping procedure. After 46 hours of stirring, a clear solution having an elevated viscosity is obtained.

In order to adjust a viscosity that is comparable to the base system, which is judged visually by examining the stirring vortex, the following amounts of distilled water are added, followed by stirring:

| | Addition in grams | Stirring time in hours | Solution |
|---|---|---|---|
| 1. | 1.28 | 70 | clear |
| 2. | 1.20 | 142 | clear |
| 3. | 1.35 | | clear |

After the third addition of water, no perceptible change in the viscosity occurs any longer.

The analytical data of the solution thus obtained reveals the following: 6.26% Na₂O, 24.18% SiO₂, solids content 30.61%, molar modulus 3.96, pH 11.13.

The solution is applied (weight per unit area: 0.1 g/cm²) onto a plastic film (PET) and dried in an oxygen atmosphere (flow rate: 100 liters per hour) at 100° C. [212° F.].

A clear layer with few cracks is formed after the drying to a residual moisture of 25%.
1.1.3 Modulus Increase up to 4.5:

6.10 grams of Klebosol 30R9 (colloidal silica stabilized with sodium oxide, 30.4% SiO₂, 0.7% Na₂O, pH 10.5, radius 9 nm) are dripped into 19.96 grams of Crystal 0075 (sodium-water glass, 8.32% Na₂O, 28.11% SiO₂, solids content 36.43%, molar modulus 3.49, pH 11.18) in a reaction vessel within 6 hours while being stirred (700 rpm) at room temperature. During the dripping procedure, the viscosity rises, and the liquid becomes turbid.

In order to adjust a viscosity that is comparable to the base system, which is judged visually by examining the stirring vortex, the following amounts of distilled water are added, followed by stirring:

| | Addition in grams | Stirring time in hours | Solution |
|---|---|---|---|
| 1. | | 48 | suspension |
| 2. | 1.38 | 72 | suspension |
| 3. | 1.27 | 144 | gel, clear |
| 4. | 1.52 | 168 | suspension |
| 5. | 1.31 | 216 | suspension |
| 6. | 1.23 | 504 | clear |
| 7. | 1.32 | | clear |

After the last addition of water, no perceptible change in the viscosity occurs any longer.

The analytical data of the solution thus obtained reveals the following: 4.97% Na₂O, 21.90% SiO₂, solids content 26.87%, molar modulus 4.55, pH 11.02.

The solution is applied (weight per unit area: 0.1 g/cm²) onto a plastic film and dried in an oxygen atmosphere (flow rate: 100 liters per hour) at 100° C. [212° F.]. A clear layer with cracks is formed after the drying to a residual moisture of 25%.
1.1.4 Modulus Increase up to 5.3:

11.45 grams of Klebosol 30R9 (colloidal silica stabilized with sodium oxide, 30.4% SiO₂, 0.7% Na₂O, pH 10.5, radius 9 nm) are dripped into 20.07 grams of Crystal 0075 (sodium-water glass, 8.32% Na₂O, 28.11% SiO₂, solids content 36.43%, molar modulus 3.49, pH 11.18) in a reaction vessel within 7 hours while being stirred (700 rpm) at room temperature. During the dripping procedure, the viscosity rises, and the liquid becomes turbid.

In order to adjust a viscosity that is comparable to the base system, which is judged visually by examining the stirring vortex, the following amounts of distilled water are added, followed by stirring:

| | Addition in grams | Stirring time in hours | Solution |
|---|---|---|---|
| 1. | | 48 | suspension |
| 2. | 1.60 | 72 | suspension |
| 3. | 1.53 | 144 | suspension |
| 4. | 1.67 | 216 | suspension |
| 5. | 1.19 | 504 | suspension |
| 6. | 1.45 | 865 | suspension |

After the last addition of water, no perceptible change in the viscosity occurs any longer.

The analytical data of the solution thus obtained reveals the following: 4.27% Na₂O, 22.09% SiO₂, solids content 26.36%, molar modulus 5.34, pH 10.83.

The suspension is applied (weight per unit area: 0.1 g/cm²) onto a plastic film (PET) and dried in an oxygen atmosphere (flow rate: 100 liters per hour) at 100° C. [212° F.].

A clear layer with cracks is formed after the drying to a residual moisture of 25%.
1.2 Example for Changing the Solids Content

5% glycerin is added to a standard solution of Na-water glass. The solution has the following composition:

26.94% SiO₂, 8.14% Na₂O, 5.63% glycerin, solids content 40.72%. The addition of distilled water yields the following solutions:

Solution A: solids content 40.72%

Solution B: solids content 38.17%

Solution C: solids content 35.63%

Solution D: solids content 33.07%

Solution E: solids content 30.53%

These solutions are dried in an oxygen atmosphere (flow rate: 100 liters per hour) at a temperature of 100° C. [212° F.] until a residual moisture content of 25% is reached. The concentrated loads of the films thus obtained is determined.

Concentrated Load

In order to determine the mechanical strength, the-films are exposed to a concentrated load exerted perpendicular to the surface.

The film is clamped into a circular frame (diameter=70 mm).

The load is exerted in the center by means of a plunger that can be weighed down with weights (discrete masses).

The end of the plunger that presses onto the film is semi-circular in shape (diameter=32 mm).

In order to measure the elongation, a plunger is moved underneath the film, likewise in the center. The end of the plunger that comes into contact with the film is semi-circular in shape (diameter=3 mm).

The distance traversed is recorded by a gauge (scale graduation of 0.01 mm) that is connected to the plunger.

The criterion that applies to the measured results is material failure as a function of the exerted mass, elongation and loading time. (Different characteristic curves for tough, ductile or brittle films.)

The table below shows the results:

TABLE
Influence of the solids content on the concentrated load

| | | % residual | | | |
|---|---|---|---|---|---|
| | % solids | moisture in | sₘₐₓ | mₘₐₓ | sₘₐₓ/ |
| Solution | content | the film | in mm | in grams | mₘₐₓ · 10⁻³ |
| A | 40.72 | 24.91 | 2.62 | 706.5 | 3.7 |
| B | 38.17 | 24.37 | 3.09 | 1406.5 | 2.2 |
| C | 35.63 | 26.18 | 3.35 | 806.5 | 4.2 |
| D | 33.07 | 25.68 | 4.35 | 806.5 | 5.4 |
| E | 30.53 | 25.23 | 5.35 | 606.5 | 8.8 |

The results show that the elongation sₘₐₓ increases when the solids content decreases. If the quotient of sₘₐₓ and mₘₐₓ is used as a measure of the mechanical properties, an optimum is obtained between a solids content of 35% to 40%.
1.3 Change in the Material Composition; Incorporation of Elements and Their Compounds that Form High-Melting Oxides

In order to improve the thermal stability of the fire protection film during the high-temperature phase of a fire, it is necessary to modify the low-melting Na-silicate systems. In this manner, thin and high-performance fire protection systems can be produced.

A major problem in the production of fire protection layers in highly alkaline base systems is the precipitation of the hydroxide or oxide phases of important glass-forming or glass-converting elements. Consequently, in an especially preferred embodiment of the invention, layer silicates and layer silicic acids are used as “Trojan horses” for the incorporation of high-melting oxides of the elements of the 2^{nd} and 3^{rd} main groups of the periodic table and of the 4^{th} subgroup of the periodic table, for example, Mg, Ca, Ti, Zr and/or Al.

Surprisingly, it was found that the incorporation of polyvalent cations into alkali silicate solutions—without the familiar precipitation of insoluble silicate compounds that is used technically, for example, with Ca²⁺ ions for soil compacting or with Al³⁺ ions for the production of zeolites—is successful if these polyvalent cations are incorporated via the route of their insertion into layer silicates, preferably having a nanoparticulate structure.

The incorporation of organic compounds is possible by using these layer silicates since, among other things, quatemary ammonia compounds with organic residual functions are bound or inserted and hence can be additionally incorporated into the matrix. In this manner, all possibilities of organic polymer chemistry can be made available and utilized for the production of fire protection film systems.

Studies on the Melt Behavior In order to have a positive influence on the melting behavior of the fire protection layers, that is to say, to create a more viscous foam that melts at higher temperatures, it is advantageous to incorporate high-melting oxides such as, for example, ZrO₂, CaO, MgO, Al₂O₃ (in general: elements of the 2^{nd} and 3^{rd} main groups of the periodic table and of the ₄th subgroup of the periodic table) into the fire protection films.

In a preferred embodiment, the MgO is incorporated via a magnesium layer silicate made by the Rockwood company (Laponite product group). Theoretical calculations according to Lakatos show that the viscosity of a standard water glass (28% SiO₂, 8.3% Na₂O) rises by about 5% through the addition of 5.3% Laponite RD in the temperature range from 700° C. to 1000° C. [1292° F. to 1832° F.].

This behavior has been confirmed through laboratory studies based on the hemisphere-point method. Thus, the hemisphere-point of the Mg-doped water glass rises by 20° C. [36° F.] in comparison to pure water glass.
1.3.1 Mg Trisilicate

Each time, 22.5 grams of Crystal 0075 are weighed into six Erlenmeyer flasks (01-06) with a ground glass joint and equipped with agitator vanes.

While being stirred (500 rpm), Mg trisilicate MS15 is added to three of the Erlenmeyer flasks and three different weights of MG trisilicate MS33 are added to the other three Erlenmeyer flasks (see table below).

TABLE
Addition of various amounts of Mg trisilicate

| | Crystal 0075 | MS15 | MS33 | |
|---|---|---|---|---|
| No. | in grams | in grams | in grams | Film |
| 01 | 22.53 | 0.23 | — | clear+ |
| 02 | 22.61 | 0.70 | — | turbid |
| 03 | 22.51 | 1.18 | — | turbid |
| 04 | 22.45 | — | 0.23 | clear+ |
| 05 | 22.30 | — | 0.70 | turbid |
| 06 | 22.50 | — | 1.18 | turbid |

The mixtures are stirred at STP (standard temperature and pressure) for 20 hours in closed Erlenmeyer flasks until homogenized.

The mixtures are applied (weight per unit area: 0.14 g/cm²) onto a plastic film (PET) and dried in an oxygen atmosphere (flow rate: 100 liters per hour) at 80° C. [176° F.] until a residual moisture content of 20% to 25% is reached.

The films thus obtained having low contents of Mg trisilicate remain clear and without turbidity. Therefore, the introduction of certain amounts of magnesium is possible via this route, for example.
1.3.2 Layer Silicates, Layer Silicic Acids

As a function of the desired product, the crystallization of the various layer silicates takes place either hydrothermally or anhydrously. The production process has an effect on the structure formation, on the degree of cross-linking and on the porosity, and these characterize the property profile of the substances.

The addition of small amounts of foreign elements such as, for example, boron, aluminum, phosphorus, among others, can have an impact on the crystallization and the property profile of the obtained products.

Important properties of the layer silicates and layer silicic acids are the possibility that they are suitable as support materials for catalytic processes and that they exhibit a pronounced intercalation.

Intercalation is defmed as a swelling of the layer structures in which molecules are inserted between or attached to the individual layers. Thus, different organic molecules are capable of being inserted between the layers of the crystalline silicates. In this process, the intermediate water molecules are displaced and the increased space requirement leads to a layer expansion of the silicate. Here, the layer silicic acids derived from kenyaite (H₂Si₂₂P₄₅.xH₂O) and magadite (H₂Si₁₄O₂₉.xH₂O) prove to be especially reactive for a large number of substances. Thus, for example, cationic surfactants intercalate into the magadite, coupled with layer expansion, whereas anionic and non-ionic surfactants are only bound to the external surface.

In addition to their function as “Trojan horses”, layer silicates and layer silicic acids exhibit other important property changes such as, for example, a thixotropy of the sols, which is important for the application technique, a reduction of the drying time, improved mechanical properties, an improved surface quality, better and more homogeneous foaming results, as well as an improved behavior in the high-temperature range.

In a fire experiment based on DIN 4102, a purely inorganic fire protection unit modified only with layer silicates displayed a much longer stability at 980° C. [1796° F.] than a commercially available fire protection glass that was tested in parallel. Special mention should be made of the thermal stability of the fire foam of the fire protection system modified with layer silicates which, in contrast to a commercially available alkali silicate fire protection system that was only modified organically, did not melt even at very high temperatures and still exhibited sufficient thermal and mechanical stability. Consequently, the room could be protected much longer than with the existing system.

In addition, the incorporation of layer silicates modified with phosphorus compounds was able to have a positive influence on the foaming behavior of the fire protection film system in the low and medium temperature ranges. Through the formation of a very fine and homogeneous foam structure, the thermally insulating effect was enhanced and a homogenous fracture pattern was created. As a result, more effective and durable fire protection systems can be made in actual practice.
1.3.2.1 Thixotropy

Solution A:

65.73 grams of demineralized water are weighed into an Erlenmeyer flask equipped with an agitator vane.

Subsequently, 7.32 grams of Laponite RDS are added in small quantities while being stirred (1250 rpm) at STP.

The mixture is homogenized for 5 minutes at STP with a disperser (24,000 rpm) and subsequently further homogenized for 1 hour at STP using a magnetic agitator (1250 rpm); the mixture becomes clear.

Solution B:

16.90 grams of the base system are weighed into an Erlenmeyer flask equipped with an agitator vane.

The base system is an alkali water glass with a molar modulus between 3.3 and 3.5, and containing organic additives up to 6%, whose moisture content is set at 37.5%.

Subsequently, 16.96 grams of Solution A are dripped in at STP within 10 minutes while being stirred (500 rpm).

Solution B is stirred further (350 rpm) at STP in a closed Erlenmeyer flask for 8 days; the solution is now thixotropic.
1.3.2.2 Influence on the Drying Time, the Film Thickness, the Mechanical Strength and the Foam Structure

Solutions A:

Demineralized water is weighed into three Erlenmeyer flasks (01-03) equipped with an agitator vane.

Subsequently, various weights of Laponite RDS are added in small quantities at STP while being stirred (1250 rpm).

The mixture is homogenized for 5 minutes at STP with a disperser (24,000 rpm) and subsequently further homogenized for 1 hour at STP using a magnetic agitator (1250 rpm); the mixture becomes clear.

| No. | Demineralized water in grams | Laponite RDS in grams |
|---|---|---|
| 01 | 32.51 | 0.74 |
| 02 | 32.80 | 2.36 |
| 03 | 32.65 | 3.99 |

Solutions B:

Base system is weighed into four Erlenmeyer flasks (04-07) equipped with an agitator vane.

Subsequently, various weights of Solutions A are dripped in in small quantities at STP within 5 minutes while being stirred (500 rpm).

| | Base system | Solution A01 | Solution A02 | Solution A03 |
|---|---|---|---|---|
| No. | in grams | in grams | in grams | in grams |
| 04 | 135.16 | 30.06 | — | — |
| 05 | 135.05 | — | 30.51 | — |
| 06 | 135.03 | — | — | 30.00 |
| 07 | 138.82 | — | — | — |

The Solutions B are stirred (500 rpm) at STP in closed Erlenmeyer flasks for 5 days.

Each of the Solutions B is applied (weight per unit area: 0.14 g/cm²) onto a plastic film (PET) and 5 films are made from each. The drying takes place in an oxygen atmosphere (flow rate: 100 liters per hour) at 80° C. [176° F.] until a residual moisture content of 25% to 28% is reached.

Two films from each of the Solutions B undergo concentrated-load testing within a time period of 16 to 18 hours after their production.

One film of each mixture is laminated onto one side and one film is laminated onto both sides and between float glass (4×110×110 mm).

The laminations are carried out under elevated pressure at 80° C. [176° F.] within 20 hours.

The laminated composites are stored in a drying cabinet preheated to 200° C. [392° F.] for 30 minutes, during which process the foaming takes place.

The film thickness is measured at five places (in the four comers and in the middle) with a gauge (scale graduation of 0.01 mm).

The foam structure is evaluated and the foam height of the composites laminated onto both sides is measured.

Results:

TABLE
Results of the experiments with layer silicates on the drying time, the
mechanical properties, the film thickness

| | Residual | Drying | | mₘₐₓ | | Mean film |
|---|---|---|---|---|---|---|
| | moisture | time | sₘₐₓ | in | sₘₐₓ/ | thickness |
| No. | in % | in min | in mm | grams | mₘₐₓ · 10⁻³ | in mm |
| 04 | 25.8-28.2 | 450 | 3.94 | 1000 | 3.94 | 0.74 |
| 05 | 24.6-26.7 | 420 | 2.61 | 500 | 5.22 | 0.80 |
| 06 | 26.1-26.5 | 405 | 2.00 | 300 | 6.66 | 0.82 |
| 07 | 24.8-25.4 | 450 | 3.28 | 400 | 8.20 | 0.74 |

TABLE
Results of the experiments with layer silicates on the foaming behavior

| | | Foam quality | |
|---|---|---|---|
| No. | Mean foam height in mm | (visual evaluation) | Films |
| 04 | 9.03 | ∘ | clear |
| 05 | 8.36 | + | clear |
| 06 | 7.98 | ++ | clear |
| 07 | 9.19 | − | clear |

The films obtained are clear. As the content of layer silicate increases, the drying time decreases and the mean film thickness increases slightly. The mechanical properties, measured in terms of the quotient of sₘₐₓ and m_{max,} are consistently better with the addition of layer silicate than without.

The foam formed during the foaming procedure exhibits the clear-cut tendency that the higher the layer silicate fraction is, the finer and more compact the foam is; as a result, the foam height is less.

In addition to the improved thermal-insulating property of a finer foam, the decreased foam height is desirable since the cracking/breaking of the glass caused by the mechanical work during the foaming takes place less vigorously. The resultant glass shards are smaller and they adhere to the fire protection foam thus formed.

Due to the fragmenting of glass shards and due to areas with coarse foam and large bubbles, the stability is greatly diminished, burn-through occurs at an early point in time, the thermally insulating effect is locally lost and the room protection no longer exists. The usually toxic products created during the fire are no longer held back.
1.3.2.1 Syneresis

Solutions A:

Demineralized water is weighed into three Erlenmeyer flasks (01-03) equipped with an agitator vane.

Subsequently, various weights of Laponite RDS are added in small quantities at STP while being stirred (1250 rpm).

The mixture is homogenized for 5 minutes at STP with a disperser (24,000 rpm) and subsequently further homogenized for 1 hour at STP using a magnetic agitator (1250 rpm); the mixture becomes clear.

| No. | Demineralized water in grams | Laponite RDS in grams |
|---|---|---|
| 01 | 117.59 | 1.18 |
| 02 | 113.76 | 2.32 |
| 03 | 112.41 | 3.50 |

Solutions B:

Base system is weighed into three Erlenmeyer flasks (04-06) equipped with an agitator vane.

Subsequently, various weights of Solutions A are dripped in in small quantities at STP within 5 minutes while being stirred (500 rpm).

| | Base system | Solution A01 | Solution A02 | Solution A03 |
|---|---|---|---|---|
| No. | in grams | in grams | in grams | in grams |
| 04 | 20.40 | 20.41 | — | — |
| 05 | 20.40 | — | 20.39 | — |
| 06 | 20.39 | — | — | 20.41 |

The Solutions B are stirred (500 rpm) at STP in closed Erlenmeyer flasks for 2 hours.

Each of the Solutions B are applied (weight per unit area: 0.14 g/cm²) onto a plastic film and 1 film is made from each. The drying takes place in an oxygen atmosphere (flow rate: 100 liters per hour) at 80° C. [176° F.] until a residual moisture content of 32% to 36% is reached.

A film made from each mixture is laminated onto one side of float glass (4×110×110 mm).

The laminations are carried out under elevated pressure at 80° C. [176° F.] within 20 hours.

The laminated composites are stored in a drying cabinet preheated to 200° C. [392° F.] for 30 minutes, during which the foaming takes place.

Results:

TABLE
Results of layer silicate experiments on the syneresis effect

| | | | | Surface | |
|---|---|---|---|---|---|
| | Residual | Drying | Foam quality | quality | |
| | moisture | time | (visual | (visual | |
| No. | in % | in min | evaluation) | evaluation) | Films |
| 04 | 35.9 | 315 | ∘ | −− | clear |
| 05 | 32.73 | 315 | + | − | clear |
| 06 | 32.41 | 315 | ++ | + | clear |

The films obtained are clear. The surface quality improves as the content of layer silicate increases.
1.3.3 Incorporation of Zirconium

Solution A:

79.39 grams of abs. ethanol and 10.42 grams of TEOS are weighed consecutively into an Erlenmeyer flask equipped with an agitator vane.

9.0 grams of demineralized water are added drop-wise using a disposable pipette within 5 minutes while being stirred (500 rpm). Subsequently, the mixture continues to be stirred (500 rpm) for 2.5 hours at STP and the TEOS becomes hydrolyzed.

Solution B:

79.41 grams of abs. ethanol and 23.52 grams of Tyzor ZEC are weighed consecutively into an Erlenmeyer flask equipped with an agitator vane.

9.0 grams of demineralized water are added drop-wise using a disposable pipette within 5 minutes while being stirred (500 rpm).

The solution is stirred (200 rpm) for 80 minutes in a water bath at 40° C. [104° F.]; the solution begins to become turbid.

Solution C:

2.5 ml of Solution B are placed into a reaction vessel equipped with an agitator vane. 10 ml of Solution A are dripped in at STP within 5 minutes while being stirred (1250 rpm).

Then Solution C is allowed to continue to react at STP for 125 minutes.

Base system is weighed into four Erlenmeyer flasks equipped with an agitator vanes. while being stirred (500 rpm) at STP, different weights of Solution C are dripped in within 5 minutes and then the mixtures are stirred (350 rpm) at STP for 17.5 hours.

Demineralized water is added to Mixtures 03 and 04; all of the mixtures are stirred (350 rpm) at STP for 14 days.

| | Base system | Solution C | Demineralized | |
|---|---|---|---|---|
| No. | in grams | in grams | water in grams | Film |
| 01 | 22.65 | 0.22 | — | milky |
| 02 | 22.27 | 0.45 | — | milky |
| 03 | 22.82 | 0.73 | 5.14 | clear |
| 04 | 22.65 | 1.18 | 5.05 | partially clear |

The mixtures are applied (weight per unit area: 0.14 g/cm²) onto a plastic film and dried in an oxygen atmosphere (flow rate: 100 liters per hour) at 80° C. [176° F.] until a residual moisture content of 27% to 29% is reached.

One of the films thus obtained is clear. This shows that the possibility exists to utilize the described synthesis route to introduce zirconium in certain amounts into the system and to obtain transparent products.
1.3.4 Introduction of Boron:

Borax

Crystal 0075 is weighed into two Erlenmeyer flasks equipped with agitator vanes. The borax is added while being stirred (300 rpm) in small quantities within 5 minutes.

The mixtures are stirred (300 rpm) at STP for 10 days until homogenized.

| | Crystal 0075 | Borax | Homogenization | |
|---|---|---|---|---|
| No. | in grams | in grams | time in days | Film |
| 01 | 30.07 | 0.30 | 10 | clear |
| 02 | 30.06 | 0.93 | 10 | clear |

The solutions are dried (weight per unit area: 0.14 g/cm²) on a plastic film in an oxygen atmosphere (flow rate: 100 liters per hour) at 80° C. [176° F.] until a residual moisture content of 18% is reached.

The films obtained are clear. Boron can be introduced into the system in certain amounts without impairing the transparency of the products.
1.4 Na/K Ratio

The addition of potassium has a positive impact on the homogenization of the foam structure, on the improvement of the mechanical properties and on the reduction of the drying time.

Production of the Na-Water Glass Solutions:

Solution A:

450 grams of Crystal 0075 are weighed into a ground glass flask. Subsequently, 120 grams of demineralized water are added and homogenized at STP for 1 day while being stirred (500 rpm).

Solution B:

360 grams of Crystal 0075 are weighed into an Erlenmeyer flask.

Subsequently, 80 grams of demineralized water are added and homogenized at STP for 1 day while being stirred (500 rpm).

Solution C:

425 grams of Solution B are added to Solution A and homogenized at STP for 1 day while being stirred (500 rpm).

Production of the K-Water Glass Solution:

Solution D:

82 grams of KOH flakes, 50 grams of demineralized water and 270 grams of Klebosol 30R25 are consecutively weighed into an Erlenmeyer flask.

The mixture is stirred at STP for 20 hours in the closed Erlenmeyer flask; the solution becomes colorless and clear.

Production of the Various Mixed Alkali-Water Glass Solutions:

The various mixed alkali-water glass solutions are mixed in seven Erlenmeyer flasks (01-07) equipped with agitator vanes.

Solution C is weighed into the Erlenmeyer flask and then Solution D is added (see table below).

6.5 grams of glycerin are dripped into each of the mixtures using disposable pipettes while being stirred (300 rpm) at STP within 5 minutes and these mixtures are subsequently homogenized while being stirred (300 rpm).

| | Weight of Solution | Weight of Solution | Time until film |
|---|---|---|---|
| No. | C in grams | D in grams | production in days |
| 01 | 170 | 0 | 5 |
| 02 | 161.5 | 9 | 47 |
| 03 | 153 | 17 | 42 |
| 04 | 127.5 | 42.5 | 40 |
| 05 | 85 | 86 | 21 |
| 06 | 42.5 | 127.5 | 20 |
| 07 | 0 | 170 | 19 |

Four films are made from each mixture.

The mixtures are applied onto a plastic film and dried in an oxygen atmosphere (flow rate: 100 liters per hour) at 80° C. [176° F.] until a residual moisture content of 25% is reached. (Exception: 07 was dried to a residual moisture content of 15% to 20%.)

All of the films undergo concentrated-load testing within a time period of 16 to 18 hours after their production.

One film from each mixture is laminated onto one side and one film is laminated onto both sides and between float glass (4×110×110 mm).

The laminations are carried out under elevated pressure at 80° C. [176° F.] within 20 hours.

The laminated composites are stored in a drying cabinet preheated to 200° C. [392° F.] for 30 minutes, during which the foaming takes place.

The foam structure is evaluated visually.

Results:

TABLE
Results from the mixed alkali-water glass experiments

| | | Drying | | | | |
|---|---|---|---|---|---|---|
| | | time | sₘₐₓ | mₘₐₓ | sₘₐₓ/ | Foam |
| No. | Na/K | in min | in mm | in grams | mₘₐₓ · 10⁻³ | quality |
| 01 | 100/0 | 545 | 3.09 | 1100 | 2.81 | Tendency: |
| 02 | 95/5 | 465 | 4.03 | 1300 | 3.10 | becoming |
| 03 | 90/10 | 470 | 3.32 | 500 | 6.64 | coarser |
| 04 | 75/25 | 385 | 1.29 | 1000 | 1.29 | |
| 05 | 50/50 | 350 | — | — | — | |
| 06 | 25/75 | 340 | — | — | — | |
| 07 | 0/100 | 355 | — | — | — | |

As the potassium content increases, the drying time decreases. Up to 25% potassium, there is an increase in the homogeneity of the resultant foam.
2.0 Organic Modifications of the Base System

Organic modifications can cause the very brittle siliceous 3D network to become partially loosened up by an organic partial network or by large, bulky organic molecules (spacers), which brings about better mechanical properties. Organic modifications also change the chemical composition, thereby affecting the drying of the layers in such a way that it can take place more homogeneously and/or more quickly (also see organically modified layer silicates) and the post-condensation and its effects (e.g. syneresis) can be diminished.

Some of the organic modifications also serve as a homogenizer. They allow a coupling of the organic phase to the inorganic phase (e.g. MTEOS, TEOS, GPTS).
2.1 Introduction of Glycerin
2.2.1 Drying Time

25.52 grams of Crystal 0075 (sodium-water glass, 8.32% Na₂O, 28.11% SiO₂, solids content 36.43%, molar modulus 3.48, pH 11.18) are placed into a reaction vessel. Various amounts of glycerin are dripped in at room temperature. This is stirred until clear solutions are formed. These solutions are applied (weight per unit area: 0.1 g/cm²) onto a plastic film. (PET) and dried in an air atmosphere at a temperature of 80° C. [176° F.] until a residual moisture content of 25% is reached.

The following table shows the results when the glycerin content is varied:

TABLE 1
Results of the introduction of glycerin
Glycerin in Na-water glass (Crystal 0075)

| % | | Drying | |
|---|---|---|---|
| glycerin | | time until | |
| in the | % glycerin | 25% residual | Visual evaluation |
| solution | in the film | moisture | of the film |
| 0 | 0 | >500 minutes | Clear, many cracks and bubbles |
| 1.35 | 2.68 | >500 minutes | Clear, many cracks and bubbles |
| 2.06 | 4.05 | >500 minutes | Clear, cracks and bubbles |
| 3.19 | 6.15 | >500 minutes | Clear, cracks and bubbles |
| 3.87 | 7.38 | >500 minutes | Clear, few cracks and few bubbles |
| 5.91 | 10.89 | 495 minutes | Clear, no cracks and no bubbles |
| 6.51 | 11.91 | 465 minutes | Clear, no cracks and no bubbles |
| 7.64 | 13.74 | 405 minutes | Clear, no cracks and no bubbles |
| 8.4 | 14.94 | 370 minutes | Clear, no cracks and no bubbles |
| 9.59 | 16.76 | 380 minutes | Clear, no cracks and no bubbles |
| 9.84 | 17.13 | 310 minutes | Clear, no cracks and no bubbles |
| 10.88 | 18.66 | 245 minutes | Clear, no cracks and no bubbles |
| 10.93 | 18.72 | 240 minutes | Clear, no cracks and no bubbles |
| 11.68 | 19.8 | 235 minutes | Clear, no cracks and no bubbles |
| 12.46 | 20.88 | 220 minutes | Clear, no cracks and no bubbles |
| 14.05 | 23.04 | 210 minutes | Clear, no cracks and no bubbles |

It was found that glycerin brings about an improvement of the surface and that fewer cracks and bubbles are formed. Moreover, it was found that the drying time is reduced. This is presumably due to the delay in the skin formation on the surface of the layer system where the cross-linking silicate system forms a diffusion barrier layer.
2.1.2 Mechanical Properties

A base system is weighed into five Erlenmeyer flasks equipped with agitator vanes.

Subsequently, anhydrous glycerin is dripped in using disposable pipettes within 5 minutes while being stirred (400 rpm) at STP.

Subsequently, the mixtures are stirred (500 rpm) at STP for 20 hours until homogenized.

| No. | Base system in grams | Glycerin in grams |
|---|---|---|
| 01 | 127.59 | 1.29 |
| 02 | 127.82 | 3.95 |
| 03 | 126.42 | 6.68 |
| 04 | 124.89 | 9.40 |
| 05 | 111.57 | 11.03 |

From each of the solutions, four films are made on one plastic film and two films are made on plastic films. The drying is carried out (weight per unit area: 0.14 g/cm²) in an oxygen atmosphere (flow rate: 100 liters per hour) at 80° C. [176° F.] until a residual moisture content of 24.6% to 28.4% is reached.

The films dried on the plastic film undergo concentrated-load testing within a time period of 16 to 18 hours after their production.

The film thickness is measured at five places (in the four comers and in the middle) with a micrometer caliper and the value is averaged.

The haze value of the dried films is measured in four places.

Results:

TABLE
Results of experiments on the glycerin content

| | Residual | | | | |
|---|---|---|---|---|---|
| | moisture | Drying time | sₘₐₓ | mₘₐₓ | sₘₐₓ/mₘₐₓ · |
| No. | in % | in min | in mm | in grams | 10⁻³ |
| 01 | 26.4-27.1 | 455 | 1.9 | 1300 | 0.92 |
| 02 | 25.4-26.2 | 465 | 1.9 | 900 | 2.11 |
| 03 | 24.6-25.3 | 480 | 2.6 | 1300 | 2.0 |
| 04 | 24.6-24.9 | 427 | 4.3 | 300 | 14.30 |
| 05 | 25.0-25.1 | 370 | 3.8 | 400 | 9.50 |

| No. | Film thickness in mm | Haze in % | Films |
|---|---|---|---|
| 01 | 0.45-0.62 | 1.6-3.7 | clear |
| 02 | 0.43-0.58 | 0.14-0.62 | clear |
| 03 | 0.46-0.60 | 0.11-0.34 | clear |
| 04 | 0.39-0.57 | 0.04-0.27 | clear |
| 05 | 0.21-0.38 | 2.51-9.73 | clear |

The films are clear. As the content of glycerin increases, the drying time decreases and the surface quality improves. As far as the elongation is concerned, an optimum is found to lie between 10% and 15%.
2.2 Introduction of MTEOS:

20.00 grams of Crystal 0075 (sodium-water glass, 8.32% Na₂O, 28.11% SiO2, solids content 43%, molar modulus 3.48, pH 11.18) are placed into a reaction vessel. Subsequently, 0.21 grams of MTEOS (trimethoxy methyl silane) are dripped in. The resultant emulsion is stirred (700 rpm) at room temperature. After 10 minutes, the viscosity rises and after 2 hours, a gel has formed. After 17 hours of stirring, no change has occurred. 3.98 grams of demineralized water are added to the gel while being stirred. Via an emulsion, a clear solution is formed from the gel and it smells strongly of MTEOS. The solution is applied (weight per unit area: 0.07 g/cm²) onto a plastic film and dried in an oxygen atmosphere at a temperature of 100° C. [212° F.] until a residual moisture content of 25% is reached. The film thus obtained is clear but has many cracks and bubbles.

19.98 grams of Crystal 0075 (sodium-water glass, 8.32% Na₂O, 28.11% SiO₂, solids content 36.43%, molar modulus 3.48, pH 11.18) are placed into a reaction vessel.

Subsequently, 1.01 grams of glycerin are dripped in. This is stirred (700 rpm) at room temperature until a clear solution is formed. 0.20 grams of MTEOS (trimethoxy methyl ilane) are dripped into this solution, thus forming an emulsion. This is stirred (700 rpm) at room temperature. After 10 minutes, the viscosity rises and after 2 hours, no more vortex can be seen; a solution has been formed. After 17 hours of stirring, no change has occurred. 4.04 grams of demineralized water are added to the solution. The viscosity of the solution drops, the solution is clear and it smells strongly of MTEOS.

The solution is applied (weight per unit area: 0.07 g/cm²) onto a plastic film and dried in an oxygen atmosphere until a residual moisture content of 25% is reached.

The film thus obtained is clear, has no cracks and few bubbles.

Table 2 below shows the results when the content of MTEOS is varied:

TABLE 2
Results of the introduction of MTEOS

| | | | | |
|---|---|---|---|---|
| % MTEOS | | Residual | | |
| in the | % MTEOS | moisture | | |
| solution | in the film | in the film | Modulus | Visual evaluation |

MTEOS in Na-water glass (Crystal 0075)

| | | | | |
|---|---|---|---|---|
| 0.00 | 0.00 | 25.45% | 3.48 | cracks and many |
| | | | | bubbles |
| 0.87 | 2.09 | 25.97% | 3.51 | cracks and many |
| | | | | bubbles |

MTEOS in Na-water glass (Crystal 0075) + 5% glycerin

| | | | | |
|---|---|---|---|---|
| 0.00 | 0.00 | 25.56% | 3.48 | few bubbles |
| 0.79 | 1.82 | 25.86% | 3.50 | few bubbles |
| 1.60 | 3.67 | 24.65% | 3.52 | few bubbles |
| 2.83 | 6.14 | 25.01% | 3.54 | bubbles |
| 3.92 | 9.15 | 24.32% | 3.56 | clusters and bubbles |

The experiments show that the addition of glycerin facilitates the introduction of MTEOS. The brittleness decreases.
2.3 Introduction of TEOS:

19.98 grams of Crystal 0075 (sodium-water glass, 8.32% Na₂O, 28.11% SiO₂, solids content 36.43%, molar modulus 3.48, pH 11.18) are placed into a reaction vessel. Subsequently, 0.21 grams of TEOS (tetraethyl orthosilicate) are dripped in, thus forming an emulsion. This is stirred (700 rpm) at room temperature for 17 hours. 3.99 grams of demineralized water are added to the resultant gel while being stirred. The solution thus obtained is clear and smells slightly of TEOS.

The solution is applied (weight per unit area: 0.07 g/cm²) onto a plastic film and dried in an oxygen atmosphere at a temperature of 100° C. [212° F.] until a residual moisture content of 25% is reached. The film thus obtained is clear but has many cracks and bubbles.

20.03 grams of Crystal 0075 (sodium-water glass, 8.32% Na₂O, 28.11% SiO₂, solids content 36.43%, molar modulus 3.48, pH 11.18) are placed into a reaction vessel. Subsequently, 1.02 grams of glycerin are dripped in. This is stirred at room temperature until a clear solution is formed. 0.22 grams of TEOS (tetraethyl orthosilicate) are dripped into this solution, thus forming an emulsion. This is stirred (700 rpm) at room temperature. After 10 minutes, the viscosity rises and after 2 hours, no more vortex can be seen; a solution has been formed. After 17 hours of stirring, no change has occurred. 4.00 grams of demineralized water are added to the solution. The viscosity of the solution drops and the stirring vortex can be seen once again. The solution is clear and it smells slightly of TEOS.

The solution is applied (weight per unit area: 0.07 g/cm²) onto a plastic film and dried in an oxygen atmosphere at a temperature of 100° C. [212° F.] until a residual moisture content of 25% is reached. The film thus obtained is clear, has no cracks and few bubbles.

Table 3 below shows the results when the content of TEOS is varied:

TABLE 3
Results of the introduction of TEOS

| | | | | |
|---|---|---|---|---|
| | | Residual | | |
| % TEOS | % TEOS | moisture | | |
| in the solution | in the film | in the film | Modulus | Visual evaluation |

TEOS in Na-water glass (Crystal 0075)

| | | | | |
|---|---|---|---|---|
| 0.00 | 0.00 | 25.45% | 3.48 | cracks and many |
| | | | | bubbles |
| 0.87 | 2.10 | 25.81% | 3.50 | cracks and many |
| | | | | bubbles |

TEOS in Na-water glass (Crystal 0075) + 5% glycerin

| | | | | |
|---|---|---|---|---|
| 0.00 | 0.00 | 25.56% | 3.48 | no cracks, few |
| | | | | bubbles |
| 0.89 | 2.04 | 24.47% | 3.50 | no cracks, few |
| | | | | bubbles |
| 1.71 | 3.91 | 24.65% | 3.52 | no cracks, few |
| | | | | bubbles |
| 2.83 | 6.30 | 24.34% | 3.54 | clusters and |
| | | | | bubbles |

The experiments show that the addition of glycerin facilitates the introduction of TEOS. The brittleness decreases.
2.4.1 Introduction of GPTS (Glycidoxypropyl Trimethoxysilane)

10 grams of water, 5 grams of anhydrous glycerin and 10 grams of GPTS made by the ABCR company are placed into a reaction vessel equipped with a magnetic agitator vane. This mixture is stirred for 24 hours in a water bath at 40° C. [104° F.].

Then 100 grams of sodium-water glass (Crystal 0075 made by the INEOS company: molar modulus 3.31, 28.11% SiO₂, 8.76% Na₂O, pH 11.5) are added.

This mixture is stirred in a water bath at 40° C. [104° F.] until complete homogeni- zation; the solution becomes clear.

The mixture is then applied onto a plastic film and dried in an oxygen atmosphere (flow rate: 100 liters per hour) at 80° C. [176° F.] until a residual moisture content of 25% is reached.

The film thus formed was clear and homogeneous and had a few small bubbles. (solids content 41.49%, molar modulus 3.60, 7.01% Na₂O, 24.48% SiO₂, 5.2% C)
2.4.2 Variations in the Introduction of GPTS:

19.98 grams of Crystal 0075 (sodium-water glass, 8.32% Na₂O, 28.11% SiO2, solids content 36.43%, molar modulus 3.48, pH 11.18) are placed into a reaction vessel. Subsequently, 0.21 grams of GPTS (3-(2,3-epoxypropoxy)-propyl-trimethoxysilane) are dripped in, thus forming an emulsion. After 3 hours of stirring (700 rpm) at room temperature, no change has occurred. 4.00 grams of distilled water are added and after 17 hours of stirring, a clear solution is formed.

The solution is applied (weight per unit area: 0.07 g/cm²) onto a plastic film and dried in an oxygen atmosphere at a temperature of 100° C. [212° F.] until a residual moisture content of 25% is reached.

The film thus obtained is clear, it has few cracks and few bubbles.

20.04 grams of Crystal 0075 (sodium-water glass, 8.32% Na₂O, 28.11% SiO2, solids content 36.43%, molar modulus 3.48, pH 11.18) are placed into a reaction vessel. Subsequently, 1.00 gram of glycerin is dripped in. The mixture is stirred (700 rpm) at room temperature until a clear solution has formed. 0.21 grams of GPTS (3-(2,3-epoxypropoxy)-propyl-trimethoxysilane) are dripped into the solution thus obtained, thus forming an emulsion. After 10 minutes of stirring (700 rpm) at room temperature, a solution is obtained that no longer changes, even after 17 hours of stirring. 4.01 grams of demineralized water are added to this solution.

The clear solution is applied (weight per unit area: 0.07 g/cm²) onto a plastic film and dried in an oxygen atmosphere at a temperature of 100° C. [212° F.] until a residual moisture content of 25% is reached.

The film thus obtained is clear, and it has small cracks and few bubbles.

Table 4 below shows the results when the content of GPTS is varied:

TABLE 4
Results of the introduction of GPTS

| | | | | |
|---|---|---|---|---|
| | | Residual | | |
| % GPTS | % GPTS | moisture | | |
| in the solution | in the film | in the film | Modulus | Visual evaluation |

GPTS in Na-water glass (Crystal 0075)

| | | | | |
|---|---|---|---|---|
| 0.00 | 0.00 | 25.75% | 3.48 | small cracks and |
| | | | | bubbles |
| 0.86 | 2.09 | 25.84% | 3.50 | small cracks and |
| | | | | bubbles |
| 1.67 | 3.99 | 27.11% | 3.51 | many cracks and |
| | | | | bubbles |
| 2.51 | 5.72 | 25.66% | 3.52 | many cracks and |
| | | | | bubbles |

GPTS in Na-water glass (Crystal 0075) + 5% glycerin

| | | | | |
|---|---|---|---|---|
| 0.00 | 0.00 | 25.13% | 3.48 | few bubbles |
| 0.44 | 1.02 | 25.66% | 3.49 | few bubbles |
| 0.82 | 1.89 | 25.95% | 3.50 | few bubbles |
| 1.60 | 3.57 | 26.98% | 3.52 | few bubbles |
| 2.33 | 4.86 | 26.54% | 3.53 | few bubbles |
| 3.11 | 6.69 | 27.24% | 3.54 | few bubbles |
| 3.85 | 8.49 | 24.13% | 3.55 | clusters and bubbles |

2.5 Introduction of Surfactants

The introduction of surfactants (anionic, cationic, amphoteric and non-ionic) brings about, among other things, a change in the surface tension of the interacting constituents. This has positive effects, for example, on the wettability of the substrate, on the degassing of the sols and on the drying time. These expected influences on the system were observed with representatives of all four surfactant classes. Examples of anionic surfactants are Sulfetal LS (C) and Sulfetal 4105 (C), for cationic surfactants QMS 435 (A), of amphoteric surfactants Amphotensid D1 (C), Amphotensid EH (C) and Tegotens DO (B) and of non-ionic surfactants DBE 814 (A), DBE 821 (A), DBE 712 (A), DBE 621 (A), DBE 732 (A), DBP 534 (A), CMS 626 (A), Tegotens G826 (B), Tegopren 5847 (B), Zusolat 1008/85 (C), Propetal 340 (C), Propetal 99 (C) and Oxytal 500/85 (C).
(A) supplied by ABCR
(B) supplied by Degussa/Goldschmidt
(C) supplied by Zschimmer & Schwartz.

In a special embodiment, clear films are obtained for use in transparent fire protection systems.

25.74 grams of Crystal 0075 (sodium-water glass, 8.32% Na₂O, 28.11% SiO₂, solids content 36.43%, molar modulus 3.48, pH 11.18) are placed into a reaction vessel. Subsequently, 0.13 grams of Tegotens G826 are dripped in. Tegotens G826 (2-ethylhexyl glucoside) is a non-ionic surfactant. A clear solution is immediately formed after the addition of Tegotens G826. An emulsion is formed after 70 hours of stirring (600 rpm) at room temperature. The emulsion is applied onto a plastic film (0.1 grams of solids content per cm²). The drying is carried out in an air atmosphere at 80° C. [176° F.] until a residual moisture content of 25% is reached.

The film thus formed has almost no cracks and few bubbles.

The same experiment is carried out with a higher concentration of Tegotens G826; the results are compiled in Table 5.

1.29 grams of glycerin are weighed into a reaction vessel. 0.14 grams of Tegotens G826 are dripped in while being stirred. Tegotens G826 (2-ethylhexyl glucoside) is a non-ionic surfactant. The mixture is stirred for 1 hour at room temperature. 25.50 grams of Crystal 0075 (sodium-water glass, 8.32% Na₂O, 28.11% SiO₂, solids content 36.43%, molar modulus 3.48, pH 11.18). are added while being stirred, thus forming an emulsion. After being stirred (600 rpm) for 70 hours at room temperature, a clear solution was formed. The solution is applied (weight per unit area: 0.1 g/cm²) onto a plastic film. The drying is carried out in an air atmosphere at a temperature of 80° C. [176° F.] until a residual moisture content of 25% is reached. The film thus obtained is clear; it has almost no cracks and few bubbles.

The same experiment is conducted with a higher concentration of Tegotens G826; the results are shown in Table 5.

TABLE 5
Results of the introduction of Tegotens G826

| | | | |
|---|---|---|---|
| | | Residual | |
| % Tegotens | % Tegotens | moisture | |
| in the solution | in the film | in the film | Visual evaluation |

Tegotens G826 in Na-water glass (Crystal 0075)

| | | | |
|---|---|---|---|
| 0.52 | 1.05 | 25.32% | No cracks and |
| | | | bubbles |
| 1.04 | 2.10 | 25.41% | No cracks and |
| | | | bubbles |

Tegotens G826 in Na-water glass (Crystal 0075) + 5% glycerin

| | | | |
|---|---|---|---|
| 0.53 | 0.99 | 25.13% | few bubbles |
| 1.05 | 1.96 | 25.66% | few bubbles |

2.5 Introduction of POSS (Polyhedral Oligomeric Silsesquioxane):

100 grams of sodium-water glass (Crystal 0075 made by the INEOS company: molar modulus 3.31, 28.11% SiO₂, 8.76% Na₂O, pH 11.5) is placed into a reaction vessel.

A Pasteur pipette is used to drip 5 grains of anhydrous glycerin into the water glass. Subsequently, this mixture is homogenized for 2 hours in a water bath at 40° C. [104° F.].

1 gram of OCTA-TMA-POSS (C₃₂H₉₆O₂₀Si₈.60 H₂O) made by the Hybrid Plastics company is added to the homogenized mixture. The mixture is stirred in a water bath at 40° C. [104° F.] for 72 hours.

Then the mixture is applied onto a plastic film and dried in an oxygen atmosphere (flow rate: 100 liters per hour) at 80° C. [176° F.] until a residual moisture content of 25% is reached.

(solids content 40.44%, molar modulus 3.33, 8.26% Na₂O, 26.71% SiO₂, 1.84% C, 0.04% N)

The films thus obtained display no turbidity. POSS can be introduced as a spacer into the siliceous network.

In order to produce the film according to the invention, preferably special materials are used as an auxiliary film, release film and protective film. The application method for applying the intumescent materials into the film system depend on the rheological parameters. Thanks to this application method, the thickness tolerance is advantageously small.

A continuous method for the production of film systems has a number of advantages. Through online control, for example, a uniform product quality can be ensured. Moreover, a high yield is obtained. It is also advantageous that wet and dry film thicknesses can be easily varied. Thanks to the special conditioning methods, the chemical composition exhibits only small gradients in the x, y and z-directions, for example, of the core moisture, thus accounting for homogeneous foam formation and reliable fire and aging behavior. The conditioning times can be considerably lowered by varying the layer system and the conditioning parameters as well as by using DCCA's (drying control chemical additives) as well as other additives.

The process times can advantageously be lowered by employing cascading coating processes and thin-film drying.

Through slight changes in the film type, the hybrid film system can be systematically adapted to special fire protection requirements. Moreover, the multi-layer film system according to the invention avoids non-homogeneities in the chemical composition and thus in the physical properties over the entire thickness and width, thus allowing a systematic selection of positive property combinations in terms of optimum space protection, thermal insulation, long stability and high durability. This is another major advantage in comparison to monolayer systems since it entails fire protection and aging properties that can be produced and reproduced flexibly. Complex after-conditioning, for example, by means of artificial thermal aging, is thus likewise avoided.

Defined gradients such as, for example, moisture gradients, but also gradients of other parameters through the layer thickness, can be set, which in turn translates into a defined fire behavior. In case of fire, the foaming behavior of the fire protection layer according to the invention is consequently much more predictable than with conventionally produced fire protection layers. Aging, insulation and melting behavior can thus be better defined.

Techniques such as, for example, two-chamber drying with semi-permeable film, whose permeability can be optimally set for the individual process gases and separate gas feeds are options for producing the hybrid film system. Hence, the gas composition as well as the flow conditions can be varied, thus shortening the processing time and the quality of the product.

1. A fire protection means that is to be integrated into a construction element, wherein the fire protection means comprises at least one hybrid film system that is transparent in the visible spectrum and in which at least one film is coated with intumescent material.

2. The fire protection means according to claim 1, wherein the film system has at least one layer having a high elasticity.

3. The fire protection means according to claim 1, wherein the film system has at least one adhesive layer that facilitates integration into environments.

4. The fire protection means according to claim 1, wherein at least one constituent of the film system has a siliceous base.

5. The fire protection means according to claim 1, wherein the film system has at least one layer comprising at least one organic or inorganic constituent in which the content of said constituent(s) varies over the thickness of the layer.

6. The fire protection means according to claim 1, wherein the film system comprises several films that contain organic and/or inorganic constituents that differ from each other, at least in part.

7. The fire protection means according to claim 1, wherein the fire protection means comprises at least two films or film layers that have different chemical compositions and that are transparent at least in sections, whereby at least one of the layers is fire-retardant.

8. The fire protection means according to claim 1, wherein the film system comprises several layers.

9. The fire protection means according to claim 1, comprising a fire protection film SiO₂ and Na₂O with a mole ratio of SiO₂ to Na₂O in the range of 3.33 to 5.34.

10. The fire protection film according to claim 1, comprising a fire protection film containing high-melting silicon oxides or their precursors.

11. The fire protection film according to claim 10, wherein the high-melting oxides are present in the form of layer silicates.

12. The fire protection film according to claim 1, comprising a fire protection film containing Laponite.

13. The fire protection means according to claim 1, wherein the intumescent material, at a residual moisture of 25%, contains between 0.5% and 23% glycerin.

14. The fire protection means according to claim 1, wherein the intumescent material, at a residual moisture between 24.32% and 25.97%,
a) contains 0% to 2% MTEOS or
b) at a glycerin content of 5%,
contains 0% to 6% MTEOS.

15. The fire protection means according to claim 1, wherein the intumescent material, at a residual moisture between 24.47% and 25.81%,
a) contains 0% to 2% TEOS or
b) at a glycerin content of 5%,
contains 0% to 6% TEOS.

16. The fire protection means according to claim 1, wherein the intumescent material, at a residual moisture between 24.13% and 27.24%,
a) contains 0% to 5.5% GTPS or
b) at a glycerin content of 5%,
contains 0% to 8% GTPS.

17. The fire protection means according to claim 1, wherein the intumescent material, at a residual moisture between 25.13% and 25.66%,
a) contains 1% to 2% surfactant, especially TEGOTENS, or
b) at a glycerin content of 5%,
contains 1% to 1.96% surfactant, especially TEGOTENS.

18. Fire protection glazing, comprising at least one fire protection means according to claim 1.

19. A method for the production of a fire protection means that is to be integrated into a construction element, the fire protection means comprising at least one hybrid film system that is transparent in the visible, spectrum and in which at least one film is coated with intumescent material, comprising producing the film system in a continuous process.

20. The method according to claim 16, wherein the method comprises cascading coating processes.

21. The method according to claim 16, wherein the method comprises thin-film drying.

22. The fire protection means according to claim 1, wherein the intumescent material, at a residual moisture of 25%, contains between 7% and 23% glycerin.

23. The fire protection means according to claim 1, wherein the intumescent material, at a residual moisture of 25%, contains between 10% and 23% glycerin.

24. The fire protection means according to claim 1, wherein the intumescent material, at a residual moisture of 25%, contains between 12% and 23% glycerin.
